(19) United States
(12) Patent Application Publication
(10) Pub. No.: US 2025/0002696 A1
(43) Pub. Date: Jan. 2, 2025

(54) EXTRUDABLE BIODEGRADABLE COMPOSITION MATERIALS AND EXTRUSION PROCESS THEREOF

(71) Applicant: Nano and Advanced Materials Institute Limited, Hong Kong (HK)

(72) Inventors: Sum Hang, Grace POON, Hong Kong (HK); Yi Chen WU, Hong Kong (HK); Ka Yee HO, Hong Kong (HK)

(21) Appl. No.: 18/708,603

(22) PCT Filed: Nov. 10, 2022
(86) PCT No.: PCT/CN2022/131110

§ 371 Date: May 9, 2024

Related U.S. Application Data
(60) Provisional application No. 63/278,110, filed on Nov. 11, 2021.

(51) Int. Cl. C08L 5/04; B29C 48/00; B29C 48/08; B29C 48/09; B29C 48/285; B29C 48/29; B29K 1/00; B29K 29/00; B29K 105/00; C08J 3/205; C08J 5/18; C08J 7/12; C08K 3/16; C08K 5/053; C08K 5/092; C08K 13/02

(52) U.S. Cl. CPC C08L 5/04; B29C 48/022; B29C 48/023; B29C 48/08; B29C 48/09; B29C 48/288; B29C 48/29; C08J 3/2053; C08J 5/18; C08J 7/12; C08K 13/02; B29K 2001/08; B29K 2005/00; B29K 2029/04; B29K 2105/0038; B29K 2105/0094; B29K 2995/006; B29K 2995/0077; B29K 2995/0094; C08J 2305/04; C08J 2401/02; C08J 2403/02; C08J 2429/04; C08K 3/16; C08K 5/053; C08K 5/092; C08K 2201/014; C08L 2201/06; C08L 2205/025; C08L 2205/035; C08L 2205/06; C08L 2312/00

(57) ABSTRACT

An extrudable biodegradable composition includes seaweed nanocellulose in the range of 1 to 3 wt %; a seaweed derivative in the range of 40-99 wt %; biodegradable polymer in the range of 0-30 wt %; plasticizer in the range of 0-25 wt %; and crosslinking agent in the range of 0-15 wt %. The extrudable biodegradable composition has a viscosity greater than approximately 500 cP and an extruded product made from the extrudable biodegradable composition has a controlled water soluble or water resistant property with a tensile strength of approximately 10 to 30 MPa.

### FIELD OF THE INVENTION

The present invention relates to the field of biodegradable seaweed nanocellulose composite materials. The present invention further relates to the extrusion process for preparing a extrudable biodegradable composition product, and more particularly, to a process for the preparation of controlled water soluble or water resistant biodegradable composites with high strength that is able to be extruded into a variety of shapes.

### BACKGROUND

Recently, polylactic acid (PLA) has been commonly used as a biodegradable plastic to replace non-biodegradable petroleum plastics as packaging materials. Even though PLA is biodegradable in industrially-controlled environments, its degradation rate in compost and seawater conditions is comparatively slow. Therefore, PLA is not a fully acceptable solution to create biodegradable plastics, particularly for low-cost, single-use applications. As a result, research continues to produce commercially-acceptable, low-cost, biodegradable plastics.

Seaweed is an abundant, low-cost and biodegradable natural material that can be a good choice to be processed as an environmentally-friendly packaging material for daily use. Conventional seaweed-related biodegradable films are mainly produced by a solvent-casting method which requires a drying step to obtain the film. This traditional way of producing a film is tedious and requires a large quantity of dissolution liquid and drying energy. Furthermore, solvent casting would encounter tremendous complications during scale-up to commercial production; solvent casting also severely limits the shapes of the plastic products that may be formed. Thus, there is a need for improved seaweed-related biodegradable products and improved processes to fabricate seaweed-related materials. The present invention addresses this need.

### DESCRIPTION OF RELATED ART

U.S. Pat. No. 7,067,568 “Process of Preparation of Biodegradable Films from Semi-Refined Kappa Carrageenan” discloses a production process of biodegradable film made from semi-refined kappa carrageenan which also possesses potassium ion as a counter ion. This enables the films produced to have a high tensile strength. The strength and quality of the films were further improved by the addition of PVA as an additive, glycerol was added as plasticizer. The preparation of the film is by solvent casting method which requires a long time and controlled drying step of over 2 hours. Such solvent casting method may increase the production cost of the biodegradable film.

US Patent Publication 2014/0356490 “Edible cup and method of making the same” discloses a process of biodegradable edible container made by mold casting method. Sugar and one or more hydrocolloids such as sodium alginate, agar, carrageenan and pectin are dissolved in water with heating then poured into a mold and allowed to harden once dried. Other substances such as calcium chloride CaCl₂), glycerin and citric acid were added to modify the container's properties. The preparation process is by solvent casting in which the product shape is limited by the mold in a batch process.

China patent CN 2017/104479368B “Enhanced full-biodegradable film of a kind of nano-cellulose and preparation method there of” discloses the preparation of a nanocellulose biodegradable film using a casting method. The film is made from nanocellulose, natural polymer, defoamer, gelling materials, plasticizer and cross-linking agent. The preparation process mixes the ingredients together followed by pouring into a casting machine to form a film, followed by drying. This casting method is limited to the production of films without the ability to produce hollow tube-shaped products.

### SUMMARY OF THE INVENTION

The present invention provides biodegradable seaweed nanocellulose composite materials along with an extrusion process for the preparation of the biodegradable seaweed nanocellulose composite materials. The composition includes seaweed nanocellulose, seaweed derivatives, biodegradable polymers, plasticizer and a crosslinking agent. The extrudable composition may be formed into controlled water-soluble or water-resistant biodegradable composites with high strength that can be formed as flat sheets and hollow tubes for various applications including biodegradable straws, dinner ware, pads, and other extrudable shapes that can be biodegraded in home-use composting devices.

In one aspect, the present invention provides an extrudable biodegradable composition that includes seaweed nanocellulose in the range of 1 to 3 wt %; a seaweed derivative in the range of 40-99 wt %; biodegradable polymer in the range of 0-30 wt %; plasticizer in the range of 0-25 wt %; and crosslinking agent in the range of 0-15 wt %. The extrudable biodegradable composition has a viscosity greater than approximately 500 cP and an extruded product made from the extrudable biodegradable composition has a controlled water-soluble or water-resistant property with a tensile strength of approximately 10 to 30 MPa.

In a first embodiment of the first aspect of the present invention, the seaweed is selected from brown or red seaweed.

In a second embodiment of the first aspect of the present invention, the seaweed nanocellulose is homogenized brown or red seaweed having a particle diameter in the range of approximately 400-500 nm at a homogenizing pressure between 500 to 1000 bar.

In a third embodiment of the first aspect of the present invention, the seaweed derivative is selected from alginate, i-carrageenan, k-carrageenan, agar-agar, or mixtures thereof.

In a fourth embodiment of the first aspect of the present invention, the biodegradable polymer is selected from starch, cassava starch, polyvinyl alcohol having a molecular weight from 28,000 to 98,000 and hydrolysis from 87 to 99%, or mixtures thereof.

In a fifth embodiment of the first aspect of the present invention, the plasticizer is selected from glycerol, sorbitol or mixtures thereof.

In another embodiment of the present invention, the plasticizer is dissolved in distilled or deionized water.

In a sixth embodiment of the first aspect of the present invention, the crosslinking agent is selected from citric acid, potassium chloride, potassium hydroxide, calcium chloride, calcium acetate, calcium carbonate, calcium sulphate or mixtures thereof.

A biodegradable extruded three-dimensional shape made from the composition of the first aspect of the present invention.

A biodegradable extruded sheet made from the biodegradable composition of the first aspect of the present invention.

In another aspect, the present invention provides an extrusion process using the extrudable biodegradable composition according to the first aspect of the present invention. The process includes heating an extruder to a temperature in the range of 25 to 120° C.; delivering a premixed powder of the seaweed derivative into a feed hopper of the extruder; delivering a premixed liquid of seaweed nanocellulose, biodegradable polymer and plasticizer into the extruder via a peristaltic pump; rotating the extruder at a selected rotation speed; extruding though a die and collecting an extruded product; and drying the extruded product.

In another aspect of the present invention, the selected rotation speed is approximately 30-100 rpm.

In another aspect of the present invention, the die has a slit shape for forming a sheet shape.

In another aspect of the present invention, the die has a tubular shape for forming a tubular extruded product.

In another aspect of the present invention, further includes submerging the tubular extruded product in a bath including 5-10 wt % of a crosslinking agent.

### BRIEF DESCRIPTION OF THE DRAWINGS

Embodiments of the present invention are described in more detail hereinafter with reference to the drawings, in which:

FIG. 1 illustrates the biodegradable seaweed nanocellulose composite material in sheet shape prepared through an extrusion process.

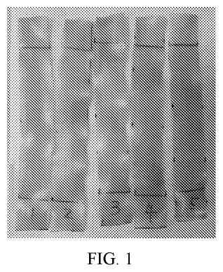

FIG. 2 illustrates the biodegradable seaweed nanocellulose composite material in hollow tube shape prepared through an extrusion process.

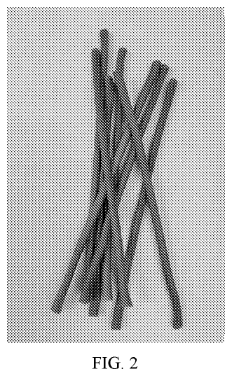

### DETAILED DESCRIPTION

The present invention relates to the preparation of biodegradable seaweed nanocellulose composite materials with controlled water-soluble or water-resistant property in various shapes such as sheets or hollow tube shapes with high tensile strength. The biodegradable seaweed nanocellulose composite materials include seaweed nanocellulose, seaweed derivatives, biodegradable polymer, plasticizer and crosslinking agent(s). The invention further includes a simple extrusion process for the preparation of the biodegradable seaweed nanocellulose composite materials.

In particular, compositions of an extrudable biodegradable composition include seaweed nanocellulose in the range of 1 to 3 wt %; a seaweed derivative in the range of 40-99 wt %; biodegradable polymer in the range of 0-30 wt %; plasticizer in the range of 0-25 wt %; and crosslinking agent in the range of 0-15 wt % based on a dry composition. For a wet composition, seaweed nanocellulose in the range of 0.5 to 1 wt %; a seaweed derivative in the range of 20-35 wt %; biodegradable polymer in the range of 0-15 wt %; plasticizer in the range of 40-65 wt %; and crosslinking agent in the range of 0-10 wt %.

In order to be extrudable, the viscosity of the composition is carefully controlled to have a viscosity greater than approximately 500 cP. At this viscosity, extruded product are self-supporting, in contrast to the prior art compositions used in solvent casting that are not self-supporting. By “self-supporting,” it is meant that a product formed in a three-dimensional shape maintains its shape after forming. That is, it does not collapse under its own weight. In particular, commercially-important shapes such as tubes, plates, and pipes.

Extrudable compositions may also be used in injection molding. Similar to extrusion, injection molding uses a rotating screw to advance the composition and, typically, an ejector mechanism to force the composition into a mold. Injection molded products may have a greater variety of shapes than extruded products. For example, injection molded single-use plastic articles include plastic containers and lids, utensils, plates, cups, and other related products. The extruded or molded products made from the extrudable biodegradable compositions has a controlled water-soluble or water-resistant property with a tensile strength of approximately 10 to 30 MPa. This level is sufficiently strong enough for single-use food-containers, food-related utensils, dinnerware, etc.

### Composition Components

### 1. Seaweed Nanocellulose

Nanocellullose from seaweed includes nanosized cellulose fibrils/fibers and/or cellulose nanocrystals Seaweed nanocellulose exhibits pseudo-plastic properties and can have gel-like consistency in the presence of a liquid. Seaweed nanocellulose is homogenized brown or red seaweed having a particle diameter in the range of approximately 400-500 nm at a homogenizing pressure between 500 to 1000 bar.

Brown seaweed (phaeophyta) includes fucoxanthin while rhodophyta is red seaweed that contains phycobiliprotein. Dried seaweed includes total lipids 0.5-3.5%, proteins 3-50%, total carbohydrates 21-61%, and minerals 12-46%. Because seaweed grows in water, it does not require land, fertilizer, pesticides, irrigation; as such, it is a sustainable source for the biodegradable products of the present invention. In particular, brown seaweeds are among the most abundant and are found throughout the world. The seaweed nanocellulose is used in an amount of 1 to 3 wt % based on the dry composition.

### 2. Seaweed Derivatives

Cellulose is present in the seaweed cell walls as well as polysaccharides. Polysaccharides are high molecular weight macromolecules that can form highly viscous solutions or dispersions with pseudoplastic flow properties and can be used to tune the viscosity of the compositions of the present invention depending upon the fabrication technique selected to form the biodegradable products (e.g., extrusion, injection molding). Particular seaweed derivative polysaccharides that may be used include alginate, i-carrageenan, k-carrageenan, agar-agar, or mixtures thereof.

### 3. Biodegradable Polymer

The biodegradable polymer may be starch, cassava starch, or polyvinyl alcohol. The biodegradable polymer may have a molecular weight from 28,000 to 98,000 and hydrolysis from 87 to 99%. Mixtures of the biodegradable polymers may also be used.

### 4. Plasticizer

The plasticizer may be glycerol, sorbitol or mixtures thereof; however, other seaweed-compatible plasticizers may be used. The plasticizer may optionally be dissolved in distilled or deionized water (e.g., in the wet composition). In the wet composition set forth above, the plasticizer may be entirely water.

### 5. Crosslinking Agent

The crosslinking agent may be citric acid, potassium chloride, potassium hydroxide, calcium chloride, calcium acetate, calcium carbonate, calcium sulphate or mixtures thereof.

The above ingredients may be provided as feed materials to an extrusion apparatus. Feed materials are delivered through a solid feed hooper and a liquid port simultaneously into a twin screw extruder. A premixed solid powder of the seaweed derivates is provided. The premixed liquid includes the biodegradable polymer, the nanocellulose obtained from brown or red seaweed as strengthening materials, plasticizers and the crosslinking agent.

For a selected extruder, the temperature may be maintained in the range between 25 to 120° C. along eight heating elements in the extruder. The rotation speed of the twin screw extruder is set between 60-100 rpm. Once the material is extruded through a die slit or a hollow tube slit, the biodegradable composite material may be collected on a conveyor belt and then oven dried at 60° C. for 1-2 hours. For biodegradable composites in a hollow tube shape, an additional step of submersion in a crosslinking agent solution containing calcium ions is used prior to oven drying.

The prepared biodegradable composite in sheet shape and hollow tube shape have a composition of seaweed nanocellulose in the range of 1-3 wt %, seaweed derivatives in the range of 40-99 wt %, biodegradable polymer in the range of 0-30 wt %, plasticizers in the range of 0-25 wt %, and crosslinking agents in the range of 0-15 wt %.

The preparation of seaweed nanocellulose from brown or red seaweed utilizes mechanical homogenizing at a pressure range between 500 to 1000 bar. The seaweed nanocellulose prepared would have particle diameter in the range of 400-500 nm.

### EXAMPLES

### Example 1: Extruded Biodegradable Seaweed Nanocellulose Composite Material in Sheet Shape and its Tensile Properties

The biodegradable composite in sheet shape is produced by a twin-screw extruder. Feed materials are delivered through the solid feed hooper and the liquid port simultaneously. Premixed powder consists of cassava starch, k-carrageenan and sodium alginate. The premixed liquid consists of nanocellulose seaweed, glycerol, polyvinyl alcohol (PVA) of MW 28,200; 87-89% hydrolysis and citric acid. The temperature of the extruder is maintained in the range between 25 to 120° C. along the eight heating elements of the extruder. The rotation speed of the twin screw extruder is set at 60 rpm. Once the material is extruded through the die slit is collected on a conveyor belt and then oven dried at 60° C. Samples then were cut into a standardized rectangular size of 14 cm in length and 2 cm in width for the determination of tensile properties. For a consistent comparison, the initial grip separation and the rate of grip separation were kept at 100 mm and 50 mm/min respectively for all tested samples. The dried composition of the composite sheet and tensile properties are summarized in Table 1 and Table 2. The biodegradable composite in sheet shape is soluble in water at room temperature and would totally dissolve in three hours.

TABLE 1
Dried composition of sheet shape samples

| | | | | Seaweed | | |
|---|---|---|---|---|---|---|
| Biodegradable | | | | nanocellulose | | Crosslinking |
| polymer | | Seaweed derivatives | | Nano | | agents |
| Cassava | | | Sodium | cellulose | Plasticizer | Citric |
| starch | PVA | k- carrageenan | alginate | seaweed | Glycerol | Acid |
| (wt %) | (wt %) | (wt %) | (wt %) | (wt %) | (wt %) | (wt %) |
| 11.8 | 17.9 | 23.6 | 23.6 | 1.7 | 17.9 | 3.5 |

TABLE 2
Tensile properties of sheet shape samples

| Average | Average elongation | Average tensile |
|---|---|---|
| thickness (mm) | at break (%) | strength (MPa) |
| 0.80 | 10.10 | 11.080 |

The biodegradability of the extruded biodegradable composite in sheet shape is determined by the sample weight loss inside in a home-use composting machine and in seawater environment compare to market available biodegradable PLA+PBAT bag. The samples weight is measure for three consecutive months and record in Table 3 and 4. The extruded biodegradable composite of the said development has a much faster weight lost compared to market available biodegradable polylactic acid added with polybutylene adipate terephthalate (PLA+PBAT) bag.

TABLE 3
Sample weight loss of biodegradable composite in sheet shape inside
a home-use composting machine for three consecutive months.

| | Extruded | Market |
|---|---|---|
| | biodegradable | available |
| | composite in | PLA + |
| | sheet shape | PBAT bag |
| Initial weight (g) | 6.14 | 0.69 |
| Weight after one month (g) | 5.95 | 1.11 |
| Weight after two months (g) | 5.32 | 1.04 |
| Weight after three months (g) | 4.93 | 0.83 |
| Total weight loss % | 20% | 0% |

The biodegradable rate result of the extruded biodegradable composite in sheet shape is conducted in seawater environment. The samples weight is measure for three consecutive months and record in Table 4. The extruded biodegradable composited of the said development has a much faster weight lost compared to market available PLA+PBAT bag.

TABLE 4
Sample weight loss in sea water environment
for three consecutive months.

| | Extruded | Market |
|---|---|---|
| | biodegradable | available |
| | composite in | PLA + |
| | sheet shape | PBAT bag |
| Initial weight (g) | 1.0654 | 1.0664 |
| Weight after one month (g) | 0.3447 | 1.1291 |
| Weight after two months (g) | 0.0937 | 1.1643 |
| Weight after three months (g) | 0.0124 | 1.2024 |
| Total weight loss % | 99% | 0% |

### Example 2: Extruded Biodegradable Composite Having a Hollow Tube Shape, its Tensile Properties and Performance in Water Pass-Through Test

The biodegradable composite in hollow tube shape is produced by a twin-screw extruder. Feed materials are delivered through the solid feed hooper and the liquid port simultaneously. A powder of sodium alginate enters the extruder via a solid feed hooper. The liquid is a mixture of commercial nanocellulose or seaweed nanocellulose dispersed in distilled water. The temperature of the extruder is maintained in the range between 25 to 40° C. along the eight heating elements of the extruder. The rotation speed of the twin screw extruder is set at 70 rpm. Once the material is extruded through the hollow tube die it is collected and submerged in 10 wt % aqueous solution of calcium chloride solution for 30 minutes as a cross linking process. A rod was inserted to the center of the hollow tube to ensure the straightness shape. After cross linking process, the hollow tubes were oven dried at 60° C. for 1 hour. Tensile properties of the dried hollow tubes are determined. For a consistent comparison, the initial grip separation and the rate of grip separation were kept at 65 mm and 12.5 mm/min respectively for all tested samples. The dried composition of the composite sheet and tensile properties are summarized in Table 5 and Table 6.

TABLE 5
The dried compositions and tensile properties of
the biodegradable composite in hollow tube shape.

| | Sodium | Commercial | Seaweed |
|---|---|---|---|
| | alginate | nanocellulose | nanocellulose |
| Formulation | (wt %) | (wt %) | (wt %) |
| Hollow Tube -1 | 98.5% | 1.5% | 0 |
| Hollow Tube -2 | 98.5% | 0% | 1.5% |

TABLE 6
Tensile properties of the biodegradable
composite in hollow tube shape.

| | Average | Average | |
|---|---|---|---|
| | thickness | elongation | Average tensile |
| Formulation | (mm) | at break (%) | strength (MPa) |
| Hollow Tube -1 | 0.94 | 10.33 | 28.17 |
| Hollow Tube -2 | 0.96 | 15.68 | 24.94 |
| PLA | 0.17 | 5.77 | 31.79 |
| PLA + sugar cane | 0.54 | 3.42 | 19.94 |

The dried compositions and tensile properties of the biodegradable composite in hollow tube shape.

The biodegradable composite in hollow tube has a water resistance property at least for three hours. The water resistance ability was test by circulating distilled water through the hollow tube shape biodegradable composite. Water flowrate is controlled by a peristaltic pump at 60 ml/min and the biodegradable composite in hollow tube shape remained intact after three hours.

The biodegradability of the extruded biodegradable composite in hollow tube shape is determined by the sample weight loss inside a home-use composting machine and in seawater environment compared to market available biodegradable PLA straws. The samples weight is measure for two consecutive months and record in Table 7 and 8. The extruded biodegradable composited of the said development has a much faster weight lost compared to market available PLA straws.

TABLE 7
Sample weight loss of biodegradable composite
in hollow tube shape inside a home-use composting
machine for two consecutive months.

| | Extruded | | |
|---|---|---|---|
| | biodegradable | Market | |
| | composite in | available | Market |
| | hollow tube | PLA + sugar | available |
| | shape | cane straw | PLA straw |
| Initial weight (g) | 5.84 | 3.39 | 2.41 |
| Weight after one month (g) | 4.74 | 2.70 | 2.46 |
| Weight after two months (g) | 4.11 | 1.15 | 2.30 |
| Total weight loss, % | 29.6% | 66.1% | 4.6% |

TABLE 8
Sample weight loss in sea water environment
for two consecutive months.

| | Extruded | Market |
|---|---|---|
| | biodegradable | available |
| | composite in | PLA + sugar |
| | hollow tube shape | cane straw |
| Initial weight (g) | 1.1573 | 1.1456 |
| Weight after one month (g) | 0.0407 | 1.1398 |
| Weight after two months (g) | 0.0104 | 1.1333 |
| Total weight loss, % | 99.1% | 1.1% |

### Example 3: Other Extruded Biodegradable Seaweed Nanocellulose Composite Material in Sheet Shape and its Tensile Properties

Similar to EXAMPLE 1 another formulation of biodegradable seaweed nanocellulose composite material can be prepared.

The biodegradable composite in sheet shape is produced by a twin-screw extruder. Feed materials are delivered through the solid feed hooper and the liquid port simultaneously. Premixed powder includes cassava starch, k-carrageenan and sodium alginate. The premixed liquid includes nanocellulose seaweed, glycerol, polyvinyl alcohol (PVA) of MW 28,200; 87-89% hydrolysis and citric acid and potassium chloride. The temperature of the extruder is maintained in the range between 25 to 120° C. along the eight heating elements of the extruder. The rotation speed of the twin screw extruder is set at 60 rpm. Once the material is extruded through the die slit, it is collected on a conveyor belt and then oven dried at 60° C. Samples then were cut into a standardized rectangular size of 14 cm in length and 2 cm in width for the determination of tensile properties. For a consistent comparison, the initial grip separation and the rate of grip separation were kept at 100 mm and 50 mm/min respectively for all tested samples.

The dried composition of the composite sheet and tensile properties are summarized in Table 9 and Table 10.

TABLE 9
Composition of extruded biodegradable seaweed nanocellulose
composite material in sheet shape.

| | | | | Seaweed | | | |
|---|---|---|---|---|---|---|---|
| Biodegradable | | | | nanocellulose | | | |
| polymer | | Seaweed derivatives | | Nano | | Crosslinking agents | |
| Cassava | | k- | Sodium | cellulose | Plasticizer | Citric | Potassium |
| starch | PVA | carrageenan | alginate | seaweed | Glycerol | Acid | chloride |
| (wt %) | (wt %) | (wt %) | (wt %) | (wt %) | (wt %) | (wt %) | (wt %) |
| 16.9 | 8.5 | 28.8 | 28.8 | 1.0 | 7.6 | 4.2 | 4.2 |

TABLE 10
Tensile properties extruded biodegradable seaweed
nanocellulose composite material in sheet shape.

| Average | Average elongation | Average tensile |
|---|---|---|
| thickness (mm) | at break (%) | strength (MPa) |
| 0.83 | 5.16 | 12.36 |

### Example 4: Another Extruded Biodegradable Seaweed Nanocellulose Composite Material in Sheet Shape

Similar to EXAMPLE 1 another formulation of biodegradable seaweed nanocellulose composite material can be prepared. The dried composition of the composite sheet is summarized in Table 11.

TABLE 11
Composition of extruded biodegradable seaweed nanocellulose
composite material in sheet shape.

| Biodegradable | | | | Seaweed | | Crosslinking |
|---|---|---|---|---|---|---|
| polymer | | Seaweed derivatives | | nanocellulose | | agents |
| Cassava | | k- | Sodium | Nano cellulose | Plasticizer | Citric |
| starch | PVA | carrageenan | alginate | seaweed | Glycerol | Acid |
| (wt %) | (wt %) | (wt %) | (wt %) | (wt %) | (wt %) | (wt %) |
| 10.0 | 8.0 | 25.0 | 25.0 | 2.0 | 20.0 | 10.0 |

It should be apparent, however, to those skilled in the art that many more modifications besides those already described are possible without departing from the inventive concepts herein. The inventive subject matter, therefore, is not to be restricted except in the spirit of the disclosure. Moreover, in interpreting the disclosure, all terms should be interpreted in the broadest possible manner consistent with the context. In particular, the terms “includes,” “including,” “comprises,” and “comprising” should be interpreted as referring to elements, components, or steps in a non-exclusive manner, indicating that the referenced elements, components, or steps may be present, or utilized, or combined with other elements, components, or steps that are not expressly referenced.

1. An extrudable biodegradable composition comprising:
seaweed nanocellulose in the range of 1 to 3 wt %;
one or more seaweed derivatives in the range of 40-99 wt %;
one or more biodegradable polymers in the range of 0-30 wt %;
plasticizer in the range of 0-25 wt %;
and crosslinking agent in the range of 0-15 wt %;
wherein the extrudable biodegradable composition has a viscosity greater than approximately 500 cP and an extruded product made from the extrudable biodegradable composition has a controlled water-soluble or water-resistant property with a tensile strength of approximately 10 to 30 MPa.

2. The extrudable biodegradable composition according to claim 1, wherein the seaweed is selected from brown or red seaweed.

3. The extrudable biodegradable composition according to claim 1, wherein the seaweed nanocellulose is homogenized brown or red seaweed having a particle diameter in the range of approximately 400-500 nm at a homogenizing pressure between 500 to 1000 bar.

4. The extrudable biodegradable composition according to claim 1, wherein the seaweed derivative is selected from alginate, i-carrageenan, k-carrageenan, agar-agar, or mixtures thereof.

5. The extrudable biodegradable composition according to claim 1, wherein the biodegradable polymer is selected from starch, cassava starch, or polyvinyl alcohol having a molecular weight from 28,000 to 98,000 and hydrolysis from 87 to 99%, or mixtures thereof.

6. The extrudable biodegradable composition according to claim 1, wherein the plasticizer is selected from glycerol, sorbitol, or mixtures thereof.

7. The extrudable biodegradable composition according to claim 6, wherein the plasticizer is dissolved in distilled or deionized water.

8. The extrudable biodegradable composition according to claim 1, wherein the crosslinking agent is selected from citric acid, potassium chloride, potassium hydroxide, calcium chloride, calcium acetate, calcium carbonate, calcium sulphate or mixtures thereof.

9. A biodegradable extruded three-dimensional shape made from the composition of claim 1.

10. A biodegradable extruded sheet made from the biodegradable composition of claim 1.

11. An extrusion process using the extrudable biodegradable composition according to claim 1, comprising:
heating an extruder to a temperature in the range of 25 to 120° C.;
delivering a premixed powder of the seaweed derivative into a feed hopper of the extruder;
delivering a premixed liquid of seaweed nanocellulose, biodegradable polymer and plasticizer into the extruder;
rotating the extruding at a selected rotation speed;
extruding though a die and collecting an extruded product;
drying the extruded product.

12. The extrusion process of claim 11, wherein the selected rotation speed is approximately 30-100 rpm.

13. The extrusion process of claim 11, wherein the die has a slit shape for forming a sheet shape.

14. The extrusion process of claim 11, wherein the die has a tubular shape for forming a tubular extruded product.

15. The extrusion process of claim 14 further comprising submerging the tubular extruded product in a bath including 5-10 wt % of a crosslinking agent.

16. The extrudable biodegradable composition of claim 1, wherein the biodegradable polymer is in the range of 10 to 20 weight percent and the seaweed derivative is in the range of 40 to 60 weight percent, the plasticizer is in the range of 15 to 20 weight percent, and the crosslinking agent is in the range of 5 to 10 weight percent.

17. The extrudable biodegradable composition of claim 1, wherein the biodegradable polymer is in the range of 20 to 30 weight percent and the seaweed derivative is in the range of 40 to 60 weight percent, the plasticizer is in the range of 5 to 10 weight percent, and the crosslinking agent is in the range of 5 to 10 weight percent.

18. The extrudable biodegradable composition of claim 16, wherein the biodegradable polymer is a mixture of cassava starch and polyvinyl alcohol and the seaweed derivative is a mixture of k-carrageenan and sodium alginate.

19. The extrudable biodegradable composition of claim 17, wherein the biodegradable polymer is a mixture of cassava starch and polyvinyl alcohol and the seaweed derivative is a mixture of k-carrageenan and sodium alginate.

20. The extrudable biodegradable composition of claim 18, wherein the plasticizer includes one or more of citric acid and potassium chloride.
